(19) United States
(12) Patent Application Publication
(10) Pub. No.: US 2004/0013327 A1
(43) Pub. Date: Jan. 22, 2004

(54) Hydrostatic gas bearing

(76) Inventors: Toshio Mukai, Chiyoda-ku Tokyo (JP); Keiichi Tanaka, Saitama-ken (JP)

Correspondence Address: KENYON & KENYON, ONE BROADWAY, NEW YORK, NY, 10004, US

(21) Appl. No.: 10/344,251

(22) PCT Filed: Jul. 30, 2001
(86) PCT No.: PCT/JP01/06536

(30) Foreign Application Priority Data
Aug. 7, 2000 (JP) 2000-239061

(51) Int. Cl. F16C 32/06

(52) U.S. Cl. 384/100

(57) ABSTRACT

The present invention has its object to provide a hydrostatic gas bearing excellent in a vibration-damping characteristic. The hydrostatic gas bearing is provided with a gas ejecting equipments composed of a cylindrical fine hole having a diameter of not less than 0.04 mm and not more than 0.4 mm,wherein a helium gas is ejected through the cylindrical fine hole. The cylindrical hole has a diameter D and a length L, and in the case where a relationship of D⁴/L is not more than 2×10⁻⁴ mm³ is established, the hydrostatic gas bearing excellent in the vibration-damping characteristic is specifically realized.

### TECHNICAL FIELD

The present invention relates to a hydrostatic gas bearing utilized for a precision machine tool such as semiconductor exposure device or precision shape measuring device.

### BACKGROUND ART

In a precision machine tool such as semiconductor exposure device, various kinds of movable stages for positioning an object to be worked (workpiece) or original board with high precision have been utilized. Such movable stage includes a bearing section at which a hydrostatic gas bearing having substantially no friction has been generally utilized. Fundamental characteristics of such hydrostatic gas bearing are represented by a load, which can be born by the bearing (load capacity) and a resisting force against displacement (rigidity). However, when the hydrostatic gas bearing is utilized in an actual movable stage, a vibration-damping characteristic with respect to the vibration of the bearing constitutes an important factor on determination of responsibility of the movable stage.

The hydrostatic gas bearing is usually mounted on the side of a movable member of the movable stage and acts to float the movable member from an opposed surface by a pressure of gas ejected through the bearing, and air has been utilized as such gas in almost all case. Further, as gas ejecting equipments, is utilized a nozzle with fine hole or a porous member such as graphite, and in many cases, nozzle-type gas ejecting equipments has been widely utilized because of easiness of its manufacture.

In the known art, when the nozzle-type gas ejecting equipments is utilized, restriction of gas is performed by utilizing, as gas restricting effect, a pressure drop due to heat insulation expansion (so-called orifice restrictor) at a time when the gas is discharged through the fine hole. The orifice restrictor can be easily manufactured, but it has a vibration-damping characteristic inferior to that of a bearing utilizing a porous restrictor.

In order to obviate such defect, prior art, such as Japanese Patent Laid-open Publication No. HEI 3-213718, has further provided a method in which a depth of a pocket formed directly below a fine pore or hole is limited to a specified range to thereby realize an inherently-compensated restrictor in the pocket. However, such prior art method is utilized the pressure drop due to adiabatic (heat insulation) expansion at the time of ejecting the gas through a virtual cylinder directly below the fine hole, so that this structure is not essentially different from usual orifice type structure.

The inventors of the subject application found, in their studies of restrictor mechanism of the nozzle-type hydrostatic gas bearing, that the vibration-damping characteristic of the bearing is extremely improved by applying helium gas as exhausting gas ejected through the orifice having a specific shape, and according to such studies and considerations, the inventors conceived the present invention.

### DISCLOSURE OF THE INVENTION

An object of the present invention is to substantially eliminate defects or drawbacks encountered in the prior art mentioned above and to provide a hydrostatic gas bearing capable of providing an improved vibration-damping characteristic or performance.

This object can be achieved according to the present invention by providing a hydrostatic gas bearing provided with a gas ejecting equipments composed of a cylindrical fine hole having a diameter of not less than 0.04 mm and not more than 0.4 mm, wherein a helium gas is exhausted through the cylindrical fine hole.

The cylindrical hole is preferable to a diameter D and a length L, which have a relationship of D⁴/L being not more than 2×10⁻⁴ mm³.

A pocket is formed to a plane including the gas ejecting equipments on a bearing surface so as to have a depth of not less than 5 μm and not more than 30 μm. The pocket is preferable to compose of a groove having either one of I-shape, H-shape, [symbol] -shape, [symbol] -shape (cross-in-square shape), T-shape and L-shape.

Furthermore, it is preferred that the bearing has a bearing body to which at least one nozzle having the cylindrical hole is mounted and the nozzle and the bearing body are formed of ceramics.

According to the present invention of the characters and structures mentioned above, the helium gas is utilized as the ejecting gas below the capillary restrictor, so that the bearing excellent in the vibration-damping characteristic can be realized. In a case where a helium gas floating movable stage utilizing the ceramics for the bearing body is applied to a precision machine tool such as semiconductor exposure device requiring a high working precision, the high precision working, which is not expected in the prior art, can be realized.

The nature and further characteristic features of the present invention will be made more clear from the following descriptions made with reference to the accompanying drawings.

### BRIEF DESCRIPTION OF THE DRAWINGS

In the accompanying drawings:

FIG. 1 is a sectional view showing an essential portion of a hydrostatic gas bearing according to one embodiment of the present invention;

FIG. 2 includes views showing results of calculation of pressure drops by means of capillary restrictor and by means of inherently-compensated restrictor, in which FIG. 2A represents a graph showing a calculation result in the use of air and FIG. 2B represents a graph showing a calculation result in the use of helium gas; and

FIGS. 3A to 3F represent schematic sectional views of pocket grooves applicable to the hydrostatic gas bearing of the present invention, respectively of I-shape (FIG. 3A), H-shape (FIG. 3B), [symbol] -shape (FIG. 3C), [symbol] -shape (cross-in-square shape) (FIG. 3D), T-shape (FIG. 3E) and L-shape (FIG. 3F).

### BEST MODE OF EMBODYING THE INVENTION

One embodiment of a hydrostatic gas bearing is described hereunder with reference to the accompanying drawings.

The present invention is a hydrostatic gas bearing utilizing a cylindrical fine hole having a diameter of more than 0.04 mm and less than 0.4 mm such as capillary tube.

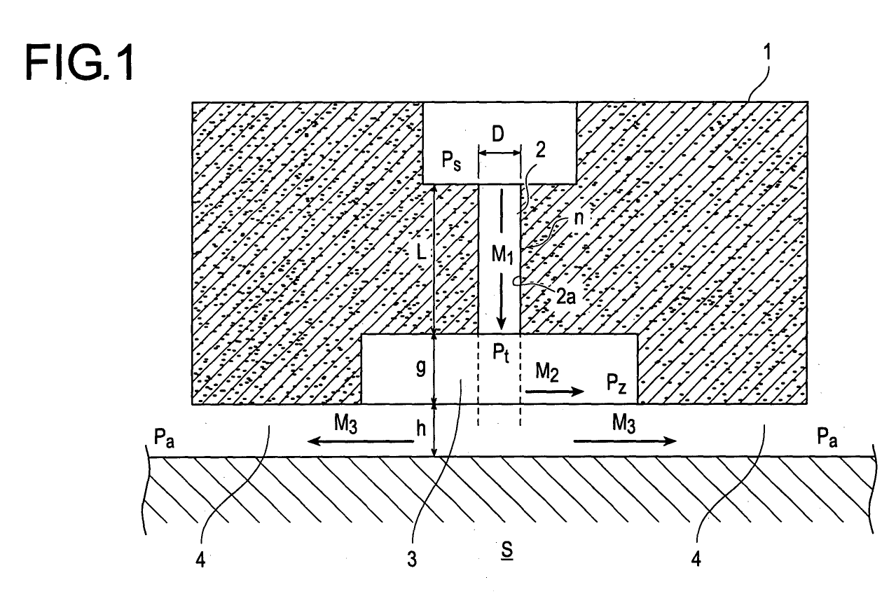

With reference to FIG. 1, showing a sectional view of an essential portion of the hydrostatic gas bearing of the present invention, a bearing body 1 is disposed so as to oppose to a shaft or planner support member S through a bearing gap 4 being present there between. This bearing body 1 is formed with a nozzle n and a pocket 3, which support the support member S in a state separated from the bearing body 1 by a gas ejected through gas supply means, not shown, towards the support member S. Further, in the illustrated state of FIG. 1, an inherently compensated restriction is realized in the pocket 3 of the bearing body 1.

The reason why a capillary restrictor means is utilized for the hydrostatic gas bearing of the present invention will be explained hereunder beforehand the explanation of an exemplary embodiment of the present invention.

With reference to the nozzle n of the hydrostatic gas bearing of FIG. 1, in a case where a gas having a supply pressure of “P^{s}” is supplied, supposing that the gas is subjected to pressure drop due to viscous at a wall surface 2a of the fine hole at a time of passing through the fine hole 2, and at the blow-out port, the pressure directly below the blow-out port becomes “Pₜ”. Supposing also that the blow-out gas is subjected to the restriction effect (in FIG. 1, inherently-compensated restriction effect) due to the adiabatic expansion at a time of expanding in the pocket 3 and the pressure inside the pocket 3 becomes “P_{z}”, and that this gas is further subjected to the viscous resistance at the bearing gap 4 at the time of being discharged outside the bearing through the pocket 3 and the pressure of the gas then becomes “Pₐ” of an external pressure.

In the above case, the process for obtaining the pressure drop ΔP induced as parameter representing restriction strength will be shown hereunder.

The capillary restriction by means of the fine hole 2 is represented as ΔP₁=Pₛ−Pₜ, and the inherently compensated restriction due to the adiabatic expansion at the blow-out port of the fine hole 2 is represented as ΔP₂=Pₜ−P_{z}.

With reference to FIG. 1, a mass flow of the gas is calculated through the following three steps.

(1) Mass flow at a time of being subjected to capillary restriction:

M₁=(πD⁴/256 μRTL)(Pₛ²−Pₜ²)

(2) Mass flow at a time of being subjected to inherently-compensated restriction due to adiabatic expansion:

M₂={APₜ/(RT)^{1/2}}ψ₀

wherein, in the case of P_{z}/Pₜ≧{2/(κ+1)}^{κ/(κ-1)},

A=πD(g+h)

ψ₀={2κ/(κ−1)}^{1/2}{(P_{z}/Pₜ)^{2/κ}−(P_{z}/Pₜ)^{(κ+1)/κ}}^{1/2}

(3) Mass flow at a time of being subjected to viscous resistance at bearing gap:

In the promise of calculation due to differential calculus, matrix indication is as follows:

M₃={(h+g)³/24μRT}[C_{i,j}P²(I,J)−C_{i,j-1}P²(I,J−1) - - - ]

wherein P(I,J) represents a pressure at a point (I,J), and C_{i,j} is a coefficient thereof.

The other parameters represent as follows:

D: diameter of fine hole; L: length of fine hole;

g: pocket depth; h: length of bearing gap;

μ: viscous efficiency of used gas; R: gas constant;

T: temperature; κ: ratio of specific heat.

Pressure distributions in the fine hole 2 and on the bearing surface are calculated through the differential calculus by applying the law of conservation of mass flow.

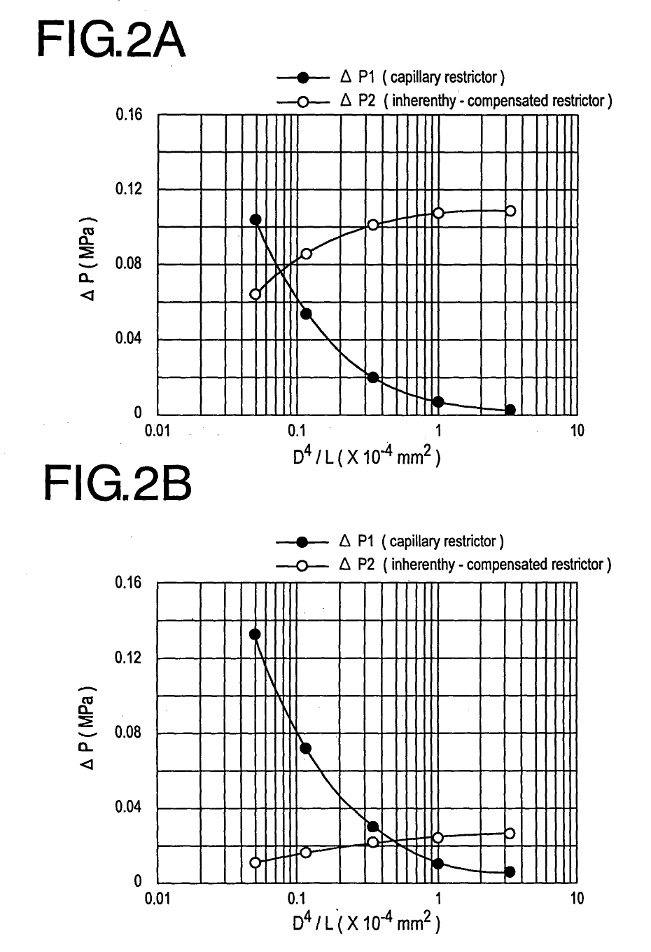

FIG. 2 shows graphs representing the results of calculation of the pressure distribution with respect to a model bearing and calculation of the pressure drops ΔP₁ and ΔP₂. The model bearing was prepared as a 60 mm square bearing having four corners at which the nozzles n are provided so as to eject the gas from four fine holes 2 each having a diameter of 0.1 mm.

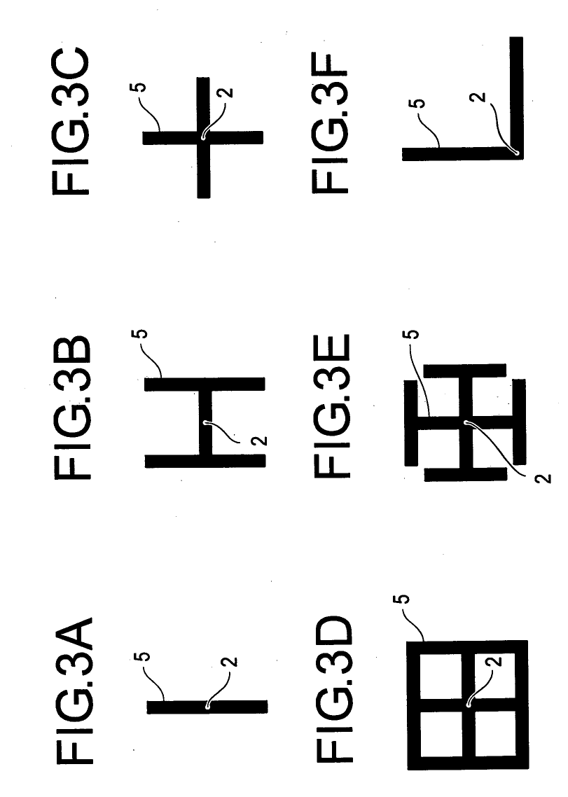

Around the fine hole 2 having a diameter of 0.1 mm, there is disposed a pocket 3 having an L-shaped groove as shown in FIG. 3F, having a depth g of 10 μm. The length h of the bearing gap 4 is of 5 μm.

The results of the calculations are shown in the graphs of FIG. 2, in which the abscissa represents the capillary restriction strength with nozzle structure parameter of D⁴/L. As shown in FIG. 2A, in the case of air, the inherently compensated restriction effect is made remarkably large, and in the practically usable range, ΔP₁<ΔP₂. On the other hand, as shown in FIG. 2B, in the case of helium gas, the above relation is reversed in the specific range of D⁴/L. That is, the capillary restriction effect exceeds the inherently compensated restriction effect (ΔP₁>ΔP₂).

The inventors of the subject application has reached to possibility of improving the vibration damping characteristic of the bearing from the fact that the capillary restrictor causes viscous resistance to gas flow at the time of theoretically obtaining such relationship as mentioned above (the first reason). This has been obtained from the following results shown in “Study Concerning Stabilizing Element Of Hydrostatic Gas Bearing” (NIPPON KIKAI GAKKAI RONBUNSYU, Vol. 32 No. 244)(1966-12), PP.1877-1882, by Mori et al.

Mori et al. showed, in their studies of restriction at a connection portion of the stabilizing element (gas bank) connecting to a pocket of the bearing, that the capillary restriction gives excellent vibration damping effect more than that of the orifice restriction. This means that the gas is air and the restriction is to the stabilizing element and not the restriction to the supply port as in the present invention, so that the result is not directly applicable. Therefore, the present invention has its novelty in that the helium gas is utilized as the gas to be used and a dominated state of the capillary restriction is realized to the restriction to the supply port.

In order to improve the stability of the bearing, it may be effective to enhance the pressure on the bearing surface (for example, refer to (NIPPON KIKAI GAKKAI RONBUNSYU, (Edition C), Vol. 58 No. 551)(1992-7), PP.186-193). From the calculation result of FIG. 2, it is shown that, in a range having a large value of D⁴/L, the pressure on the bearing surface (=Pₛ−ΔP₁−ΔP₂) is larger in the case of the helium gas than that in the case of the air (the second reason). This will be led to the improvement of the vibration-damping characteristic in the range of D⁴/L more than 2×10⁻⁴ mm³.

According to the above two reasons, the hydrostatic gas bearing utilizing the helium gas is expected to provide a largely improved vibration-damping characteristic, which has been evidenced by the inventors as will be mentioned herein later.

A preferred exemplary embodiment will be described hereunder.

Helium gas to be ejected is supplied from a helium gas supply device, which supplies the helium gas by reducing its pressure to a predetermined pressure, for example, from a high pressure storage bomb to a pressure reducing valve. Further, a device capable of supplying the helium gas at a predetermined pressure may be utilized as such helium gas supply device.

The pressure of the helium gas to be supplied to the bearing is represented by a differential pressure of, usually, 0.3 to 0.7 Mpa, and it is not absolutely necessary for the helium gas to have high purity. For the sake of cost reducing, gas other than helium may be mixed as far as it does not exceed over 50% in content. In this meaning, in the present invention, the term “helium gas” includes its mixture gas. Since argon, nitrogen, oxygen and air is an element or gas having a weight higher than that of helium, when such gas or element is mixed to the helium, it is necessary to consider the mixing ratio of these gases to the helium because such mixing weakens the effect obtainable by the invention. On the other hand, the mixture of hydrogen gas will enhance the effect of the invention because the hydrogen gas has a weight lower than that of the helium gas.

The fine hole 2 formed to the nozzle has a cylindrical shape, and a diameter of cross section of the most desired cylindrical shape is not less than 0.04 mm and not more than 0.4 mm. In the case of the diameter being less than 0.04 mm, it is difficult to industrially form or manufacture such fine hole, and on the other hand, in the case of the diameter being more than 0.4 mm, the restriction effect becomes weak, so that a desired effect of the invention is not obtainable.

Furthermore, it is required for the cylindrical fine hole 2 to have a length L more than a predetermined length in order to obtain the capillary restriction effect. The upper limit of the shape factor D⁴/L of the fine hole 2 was determined in view of the matter that the capillary restriction effect can remarkably appear at the time of the capillary restriction effect of more than 20% (ΔP₁/ΔP₂≧0.2) with respect to the adiabatic expansion restriction effect.

That is, with reference to FIG. 2B, the above condition is satisfied in the case of the shape factor D⁴/L of the fine hole 2 being not more than 2×10⁻⁴ mm³, and hence, the above condition was made as more preferred condition for the present invention. In order to maximally achieve the effect of the present invention, the condition of (ΔP₁/ΔP₂≧1) is desired.

When the length L of the fine hole in the condition of (ΔP₁/ΔP₂≧1) is obtained from the shape factor D⁴/L of the fine hole 2 satisfying the above condition with the fine hole diameter being of 0.1 mm, the length L is about 2 mm in the case of the helium gas and about 14 mm in the case of air. It is industrially difficult to form the fine hole having a length of more than 10 mm with the diameter being of 0.1 mm, and in the case of air, it is industrially impossible to realize a bearing having the capillary restriction structure. On the other hand, in the case where the helium gas is utilized as exhaust gas, a bearing having forcible capillary restriction structure can be easily realized.

In order to enhance the rigidity and load capacity, the pocket 3 is formed directly below the fine hole 2 of the nozzle n, i.e. to a plane portion including the gas exhausting port on the bearing surface. This pocket 3 may have various shapes, but in many cases, a concentric pocket may be adopted on a circular bearing surface in which a simple one nozzle n is arranged centrally. The depth of the pocket 3 is not less than 5 μm and not more than 30 μm. In the case of the pocket depth of being less than 5 μm, it is difficult to obtain a desired rigidity and, in the case of the pocket depth of being more than 30 μm, the bearing will easily cause self-excited vibration.

Furthermore, in order to enhance the operational stability of the bearing, it is desired for the pocket to have a small volume and have a groove of various shapes such as in FIGS. 3A to 3F, showing I-shape (FIG. 3A), H-shape (FIG. 3B), [symbol] -shape (FIG. 3C), [symbol] -shape(cross-in-squareshape) (FIG. 3D), T-shape (FIG. 3E) and L-shape (FIG. 3F). Further, with respect to the T-shape groove as shown in FIG. 3E, it is preferred that the fine hole 2 is formed to a position at which leg-ends of four capitals of T are focused. With respect to the L-shape groove as shown in FIG. 3F, it is preferred, in the case of arranging the nozzles n at four corner portions of a rectangular bearing, to form the fine hole 2 at the corner portion of the capital L.

Furthermore, although the various groove shapes are shown in FIG. 3, in a bearing utilizing a plurality of nozzles n, it may be possible to use these grooves in a combined manner. The depth of the groove 5 will be limited to be not less than 5 μm and not more than 30 μm because of the same reason as mentioned before with reference to the circular pocket 3.

Moreover, it is also desired, for the nozzle n and the bearing body 1 to which the nozzle n is mounted, to be formed of ceramics. As such ceramics, there will be utilized, for example, alumina, zirconia, silicon carbide, silicone nitride, SIALON, aluminium nitride and these ceramics base compound material, which are totally called fine ceramics.

The reason why the ceramics are advantageously used resides in: no generation of rust different from the case of metal material being used; stability of shape; no deformation as a structure because of its light weight and high rigidity; substantially no generation of burr, such as in the case of the metal, at the time of working the pocket through the machining working to the bearing surface; and application of various working methods such as laser working, blast working or like, which is difficult for metal working method to be done.

Since the helium gas is superior in the heat transfer property, thermal equilibrium state can be realized in relatively short time even if the ceramics having no good heat transfer property were utilized for the bearing body.

As mentioned above, in the case where the movable state made of ceramics is used as a constitutional element for a precision machine, the helium gas can advantageously reduce fluctuation of temperature in the entire system and can distribute the improvement of the working precision.

A preferred exemplary embodiment will be mentioned hereunder.

The bearing surface was determined to be a square shape having a dimension of 60×60 mm. Bearings mounted with nozzles having various fine hole shapes or forms were manufactured by using alumina ceramics, which were then subjected to tests.

The nozzles are arranged at four corner portions of the bearing, and a pocket directly below the orifice was formed to be a groove having the L-shape as shown in FIG. 3F so that the center of the bearing surface is surrounded by the groove. The depth of this groove was 10 μm. A gas is supplied to the bearing with a supply pressure having a pressure difference of 0.4 Mpa from atmospheric pressure. A floating (rising) distance, i.e., bearing gap, set by regulating the load was 5 μm.

Vibration damping was evaluated by applying impact load to the bearing. A settling time of vibration was obtained by a vibration-damping curve, and resonance frequency and damping ratio were obtained from FFT (Fast Fourier Transform) analysis of the damping curve.

From the resonance frequency, was obtained a value of rigidity (motion rigidity) at its frequency. Results of measurement with respect to various D⁴/L are shown in the following Table 1. From this Table 1, it will be found that, by using the helium gas as exhaust gas, the vibration settling time was reduced half in the case of using the air and the damping ratio became two times, in spite of providing substantially the same rigidity as in the case of the air. Thus, the remarkable vibration-damping effects could be confirmed.

TABLE 1

| | fine hole | Vibration | | Motion |
|---|---|---|---|---|
| Kind | Shape Factor | Settling Time | Damping | Rigidity |
| of Gas | D⁴/L(×10⁻⁴ m³) | Tₛ (ms) | Ratio (ζ) | K_{d} (N/μm) |
| He | 3 | 25 | 0.036 | 84 |
| | 0.3 | 18 | 0.051 | 88 |
| | 0.1 | 12 | 0.085 | 93 |
| Air | 3 | 45 | 0.022 | 87 |
| | 0.3 | 42 | 0.024 | 92 |
| | 0.1 | 28 | 0.036 | 98 |

*Vibration settling time: Time at which vibration width is settled to be 1/10.

Further, it is to be noted that the described embodiments are exemplary embodiments of the present invention, and accordingly, the present invention is not limited to the described ones and many other changes and modifications may be made without departing from the scopes of the appended claims.

1. A hydrostatic gas bearing provided with a gas ejecting equipments composed of a cylindrical fine hole having a diameter of not less than 0.04 mm and not more than 0.4 mm, wherein a helium gas is exhausted through the cylindrical fine hole.

2. A hydrostatic gas bearing according to claim 1, wherein said cylindrical hole has a diameter D and a length L, which have a relationship of D⁴/L being not more than 2×10⁻⁴ mm³.

3. A hydrostatic gas bearing according to claim 1 or 2, wherein a pocket is formed to a plane including the gas ejecting equipments on a bearing surface so as to have a depth of not less than 5 μm and not more than 30 μm.

4. A hydrostatic gas bearing according to claim 3, wherein said pocket is composed of a groove having either one of I-shape, H-shape, [symbol] -shape, [symbol] -shape, T-shape and L-shape.

5. A hydrostatic gas bearing according to any one of claims 1 to 4, wherein said bearing has a bearing body to which at least one nozzle having the cylindrical hole is mounted and said nozzle and said bearing body are formed of ceramics.
